(19) United States
(12) Patent Application Publication
(10) Pub. No.: US 2010/0294170 A1
(43) Pub. Date: Nov. 25, 2010

(54) METHOD AND INSTALLATION FOR PRODUCING MULTI-COMPONENT CEMENTS

(75) Inventors: Paul Clemens, Schoeneiche (DE); Dietmar Espig, Freiberg (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: HOLCIM TECHNOLOGY LTD, Jona (CH)

(21) Appl. No.: 12/680,121

(22) PCT Filed: Sep. 23, 2008
(86) PCT No.: PCT/EP2008/008016

§ 371 Date: Aug. 9, 2010

(30) Foreign Application Priority Data
Sep. 29, 2007 (DE) 10 2007 046 835.2

(51) Int. Cl. C04B 7/02; B02C 23/12; B02C 21/00; C04B 14/06; C04B 14/00

(52) U.S. Cl. 106/714; 241/80; 241/65; 106/756; 106/736

(57) ABSTRACT

A method for producing multi-component cements with the following procedural steps:
one component B of the multi-component cement is ground in a grinding installation MB;
Portland cement is ground as component A in a cement grinding installation MA;
the mechanically discharged grinding stock of the grinding installation MB is supplied to the inlet of a dynamic classifier with adjusted separation cut;
the Portland cement is also supplied to the inlet of the dynamic classifier of the grinding installation MB, and
the oversized material of the dynamic classifier of the grinding installation MB is recycled to the inlet of the grinding installation MB, whereas the fine product of the dynamic classifier forms the multi-component cement.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

Portland slag cements, blast furnace cements and composite cements according to the European standard “EN-197/1” consist of at least the components that are to be ground, namely cement clinker and slag sand. A sulphate carrier is added as a setting regulator.

Essentially two processing methods are distinguished for the production of such multi-component cements:
1. Common grinding and mixing of the components in a grinding aggregate, which exerts mixer functions at the same time.
2. Separate grinding of the components, the intermediate storage thereof in silos and subsequent mixing in a mixing installation according to a given recipe.

In EP 0 967 185 B1, the entire contents of which is incorporated herein by reference, the common grinding of slag sand and cement clinker and the common grinding of clinker meal and slag grit is mentioned, in each case under addition of the necessary sulphate carrier. From this state of the art, it has also become known to use slag grit instead of slag meal in an advantageous and cost-saving way, for instance when mixing Portland slag cement.

Separate grinding of slag sand and cement clinker emerges from EP 696 558 B1 for instance. A very fine multi-component cement is obtained by grinding and classifying the individual components separately with respect to selected finenesses, and subsequently mixing them in mixing installations.

From EP 0 690 828 B1, the entire contents of which is incorporated herein by reference, a method has become known in which grinding binders made of at least two main components is performed in an open circuit (continuous mill). The component with the lower resistance against grinding (clinker) is charged at the inlet of the continuous mill, together with the sulphate carrier (gypsum), and ground on its way through the mill tube to the delivery. At a location between inlet and delivery of the mill tube, the component that is more difficult to grind (pre-ground slag sand, that is to say, slag meal) is added, and both main components are ground together up to completion. In this document, it is also mentioned that slag sand or pre-ground slag sand can be added to the clinker at the mill's inlet, in order to influence the particle size distribution. It is further described to add slag sand to the slag meal between inlet and delivery, in order to influence the common final grinding.

From DE 13 35 723 C2, the entire contents of which is incorporated herein by reference, a method for producing a binder and its utilisation in a continuous tube mill has become known. In this known method, two components of different grindabilities are used, wherein one component having a better grindability is given into the inlet of a continuous tube mill and is ground on its path to the delivery of the mill. At a location between the inlet of the mill and the delivery thereof occurs the addition of the difficultly grindable component C into the tube mill in a pre-ground form. Between the location of the addition of the difficultly grindable component and the mill's delivery, all the components are subjected to a common final grinding in the tube mill. From DE 90 07 802 U1, the entire contents of which is incorporated herein by reference, a multi-component classifier has become known from which one delivery arrives in a ball mill and another one in a material bed roller mill. The delivery material of the ball mill arrives via the classifier at the inlet of the ball mill again. It is said that the energy demand will be reduced by this known continuous grinding installation.

In the common grinding, a particle size distribution is to be expected for the completed cement which is determined by the common load of the more and the less grindable components of the cement. It is not possible to adjust particle size distributions that are particularly related to the components. Only by grinding the cement components separately, the selected grinding installation can be adjusted to the resistance against grinding and the grain size of the supplied material. However, it remains disadvantageous in this that intermediate storage facilities, sumptuous transportations and mixing installations are necessary. The grinding stock that has to be provided is fixed and can no more be influenced by the mixer.

Grinding the mentioned binder constituents for the multi-component cements is performed in suitable grinding installations, which are selected according to the components that are to be ground. Therefore, one distinguishes in principle between cement mills on the one hand, and slag sand mills on the other hand. Balls mills are considered as grinding aggregates for instance, which are nowadays normally equipped with classifying liners. In slag sand mills, the balls have a diameter of about 40 to 50 mm at the inlet, and of about 17 mm at the delivery. In cement mills, the balls have a diameter of about 90 to 100 min at the inlet, and of about 12 to 17 mm at the delivery. The maximum ball diameter in a tube mill is determined by the resistance against grinding and the upper grain size of the material that is charged.

However, other binder grinding installations have become known, like for instance the roller grinding mill, the material bed roller mill, the stirred media mill or the like.

The present invention is based on the objective to provide a method and an installation by which multi-component cements can be produced in a way that saves energy cost and increases the use-value of the cements.

### BRIEF SUMMARY OF THE INVENTION

One component B of the multi-component cement, slag sand according to one embodiment of the present invention, is ground in a grinding installation MB. Because this component is relatively difficultly grindable, it is ground in a slag sand grinding installation according to one embodiment of the present invention, for instance in a usual ball mill, roller grinding mill, a material bed roller mill or the like. Portland cement is ground as component A in a cement grinding installation MA. The latter is designed for grinding clinker for making Portland cement, as has been set forth above. It is to be understood that in the present invention, the Portland cement has not to be ground in the same place as the component B. Instead, the Portland cement can be ground at any arbitrary other place, so that it can be subsequently transported to the place where the component B will be ground. This is preferably done by transportation as a bulk material.

In the present invention, the mechanically discharged grinding stock of the grinding installation MB is supplied to the inlet of a dynamic classifier with adjusted separation cut. Such dynamic classifiers are known in the production of cement or also of other powder-shaped materials. Into the grinding stock coming from the grinding installation, the ground Portland cement is supplied to the closed circuit of the slag sand grinding installation immediately before the dynamic classifier. The oversized material of the dynamic classifier, now consisting of the not sufficiently fine ground slag meal and the particles that are separated out of the Portland cement in order to be refined, is recycled to the inlet of the grinding installation MB. The fine product of the dynamic classifier forms the multi-component cement.

The component B is ground in a continuous grinding installation MBD having an inlet and a delivery, and Portland cement as component A is supplied into a cement grinding installation MA as component A. Portland cement is supplied as component A in the longitudinal direction of the continuous grinding installation MDB at one or plural locations of the continuous grinding installation. Multi-component cement is taken out of the delivery of the continuous grinding installation MBD. If the inlet location is relatively remote from the delivery of the grinding installation, there is marked grinding of the Portland cement together with the slag sand. However, if the inlet location is relatively near to the delivery, only a marginal post-refining of the Portland cement takes place at this location.

It has proven that an existing slag sand grinding installation with a dynamic classifier that is dimensioned correspondingly can be used in an advantageous manner for producing multi-component cements. As was already set forth, the basic concept of the present invention is that while the more difficultly grindable slag sand component is ground in a slag sand mill, for instance completed and standardised Portland cement of a selected consistency class is charged into the circuit before the classifier. The Portland cement is predominantly discharged with the completed multi component cement that corresponds to the desired recipe. Depending on the target fineness of the multi component cement that is to be produced, a partial and doped refinement of the Portland cement is realised in the common grinding to completion by doing so. The variable choice of the supplied Portland cement with the finenesses of CEM I 32,5 R, CEM I 42,5 R and CEM I 52,5 R or even special finenesses, the variation of the final finenesses of the multi component binders and the purposeful refinement of the used Portland cement open a wide field of realisable particle size distributions and improvements of the use value of the multi component cements.

A series of advantages is achieved with the method of the present invention.

Through the incorporation of Portland cements ground to different finenesses into the flow of grinding stock of a grinding installation that grounds slag sand, the particle size distributions of the components in multi-component cements can be purposefully influenced.

The component Portland cement is post-refined in an energetically advantageous way in the slag sand grinding installation that is significantly better burdened for fine grinding than a cement grinding installation which is usually used for multi component grinding.

When Portland cement is added into the flow of grinding stock or into the circuit, respectively, of a grinding installation that grounds slag sand, the post-refining degree of the Portland cement and the particle size distributions of the components in the multi-component cement are determined by varied finenesses of the Portland cement and selected target finenesses of the multi-component cement resulting from this.

With the present invention, partial and doped grinding or post-refining, respectively, of individual components is possible in the production of multi-component cements, as against common grinding in cement mills or mixing of intermediately stored components in mixing installations.

By optimising conventional classifiers, target finenesses between 2 500 and 7 000 cm2/g after Blaine can be reached. The utilisation of special classifiers for higher finenesses is also conceivable.

The production of cements having the same material composition with variably shaped particle size distribution of the components in order to influence the use value properties of multi-component cements is also possible with the present invention.

Through the incorporation of the Portland cement having varied grinding fineness into the circuit or the grinding stock flow, respectively, of the slag sand grinding installation, the post-refining of the Portland cement approaches a minimum when the target fineness of the multi-component cement is smaller than the fineness of the Portland cement that is incorporated into the circuit or the grinding stock flow, respectively. However, the partial post-refining is significantly high when the target fineness of the multi-component cement is substantially higher than the real fineness of the incorporated Portland cement. In each case, a considerable portion of the Portland cement charged into the classifier is discharged directly as a completed material. Thus, the grinding circuit is significantly unburdened.

The production of multi-component cements can be planned to a large extent. The production of standardised and non-standardised binders is possible on demand.

For a known reference condition of a grinding installation, the adjustment parameters of the installation for the production of multi-component cements or non-standardised multi-component binders are predictable with the aid of a flow chart based simulation. The operation of the grinding installation is advantageously simulated with sufficient accuracy by way of a flow chart simulation taking predicative calculation models as a basis, so that no further adjustments on the existing grinding installation and no further samplings and analytical expenditure are necessary for obtaining the required information.

The utilisation of mixing equipments and energy expensive in-plant transportations and/or the provision of additional silo capacity may be omitted.

It results from the mentioned advantages that the present invention is an optimum alternative to the hitherto used technologies of common grinding of the components on the one hand, and their separate grinding with subsequent mixing on the other hand. In this, the present invention permits a purposeful exertion of influence to the particle size distributions of the components, which is not possible with the previous technologies.

Advantageous embodiments of the present invention are indicated in the subclaims.

Regarding the utilisation of a continuous grinding installation, the inlet position of the Portland cement in the longitudinal direction of the continuous grinding installation is arbitrary. For instance, when a tube screw conveyor is used it is conceivable to provide the same with a series of closable outlet openings at distances in the axis direction. Thus, by corresponding choice of the outlet opening, the inlet position for the Portland cement may be changed in the continuous grinding installation. However, in order to effect a desired post-refining, it is also conceivable to charge Portland cement simultaneously into the grinding stock flow of the continuous grinding installation at plural locations that are spaced apart in the flow direction.

The delivery of the grinding installation MB working in a circuit may occur at least partially pneumatically, and the delivered material may be conveyed to the dynamic classifier. The exhaust air dust of the mill can also be supplied to the inlet of the dynamic classifier. In a continuous grinding installation, the mill's exhaust air dust can be recycled into the grinding installation, in particular by a tube screw conveyor.

The mechanically bound water is removed from the humid slag sand in a dryer. The dryer works in connection with a hot gas generator.

The pneumatic mill delivery material is brought into a static classifier, from which the oversized material is guided into the conveying track towards the dynamic classifier. The exhaust air of the static classifier is guided to an exhaust air filter, the filter dust of the exhaust air filter being also charged into the dynamic classifier.

An installation for producing a multi-component cement according to claim 13 provides a circulatory-working grinding installation MB for a component B that is to be ground, slag sand in particular. With the aid of a conveyor device, the ground material of the grinding installation is guided from the delivery thereof to the inlet of a dynamic classifier with adjusted separation cut. From the delivery of the dynamic classifier for oversized material, the oversized material is recycled to the inlet of the grinding installation MB via a back conveyor device. A reservoir for Portland cement as component A, which is connected to the conveyor device between the delivery of the grinding installation MB and the inlet of the dynamic classifier via a line, permits to supply for instance standardised Portland cement into the grinding stock flow towards the dynamic classifier of the grinding installation MB. The material to be ground for the component B, for instance slag sand, is likewise contained in a reservoir which is connected to the inlet of the grinding installation.

As an alternative to circulatory grinding, a continuous grinding installation may be provided for the component B like slag sand. The inlet of the continuous grinding installation MBD is connected to a reservoir for the material to be ground of the component B. From out the delivery of the continuous grinding installation MBD for the multi-component cement, a linear conveyor for a component A extends into the continuous grinding installation in the longitudinal direction of the continuous grinding installation MBD. The linear conveyor is connected to a reservoir for the component A. The linear conveyor has at least one delivery within the continuous grinding installation. The linear conveyor may be a tube screw conveyor for instance, which has plural outlet openings at distances along its extension.

It is usual to add a sulphate carrier in the production of Portland cement. However, according to the circumstances, the sulphate carrier content will not be sufficient in the completed multi-component cement. Therefore, one embodiment of the present invention provides that the inlet of the grinding installation MB or that of the continuous grinding installation MDB is connected to a reservoir for a sulphate carrier.

In the following, a table is shown which represents three examples for a method of the present invention.

TABLE 1
Achievable parameters for the grinding of multi-component
cements according to the present invention

| | Reference condition | | | |
|---|---|---|---|---|
| | (*) of the slag sand | | | |
| | grinding installation | Var (a) | Var (b) | Var (c) |
| Product | Slag meal | CEM II/B-S 32.5 | CEM II/A-S 52.5 | CEM III/A 52.5 |
| Overall throughput t/h | 28.5 | 96 | 39 | 23 |
| Component A (Addition | Slag sand | Slag sand | Slag sand | Slag sand |
| site: mill inlet) | | | | |
| Component B (Addition | — | CEM I/32.5 R | CEM 1/52.5 R | CEM 1/52.5 R |
| site: classifier input) | | | | |
| Recipe: A %:B % | — | 26:74 | 20:80 | 37:63 |
| Classifier separation | 27 | 100 | 28 | 11 |
| cut size μm | | | | |
| Unclassified proportion % | 25 | 20 | 25 | 30 |
| Classifier input amount t/h | 74 | 133 | 61 | 80 |
| Component B: proportion | — | 70 | 66 | 41 |
| directly into the completed | | | | |
| product via classifier % | | | | |
| Mill throughput t/h | 74 | 65 | 30 | 65 |
| Grit amount t/h | 46 | 42 | 22 | 57 |
| Elaine value cm²/g | 3980 | 3230 | 5270 | 6700 |
| d'RRSB μm | 15.5 | 22.9 | 8.8 | 6.8 |
| nRRSB | 1.03 | 0.85 | 0.9 | 1.06 |
| Wₘ overall kWh/t | 85 | 68 | 128 | 160 |

In the following, some remarks to the examples will be given:
The required starting data stem from the presumed reference condition (*), see Table 1, column 2, and from the characteristic grindability curves of the component, for instance according to the bond test or the Zeisel test.
The grain structure of the completed material was given for the respective cement species in the form of characteristic values for the desired fineness.
The essential characteristic variables summarised in the table, namely mass flows (dry), parameters of the classifier separation curve, the characteristic variables for the fineness, specific consumption of electric energy, were determined through model calculations by way of flow chart simulation.
A predicative calculation model serves for the calculation of the grinding installation within the flow chart simulation.
A suitable parameterised mapping serves for the calculation of the classifier flows: separated grain and unclassified proportion as a function of input fineness, charge and the classifier's rotational speed.
The indication of the calculated Blaine values takes the correlation between the calculated surface and available values of the Blaine analysis into account.
The procedure is primarily oriented towards the utilisation of conventional tube ball mills, but can be transferred to other grinding machines (roller grinding mills, material bed roller mills etc.).

### DETAILED DESCRIPTION OF EACH OF THE FIGURES OF THE DRAWINGS

The present invention will be explained in more detail in the following by way of drawings:

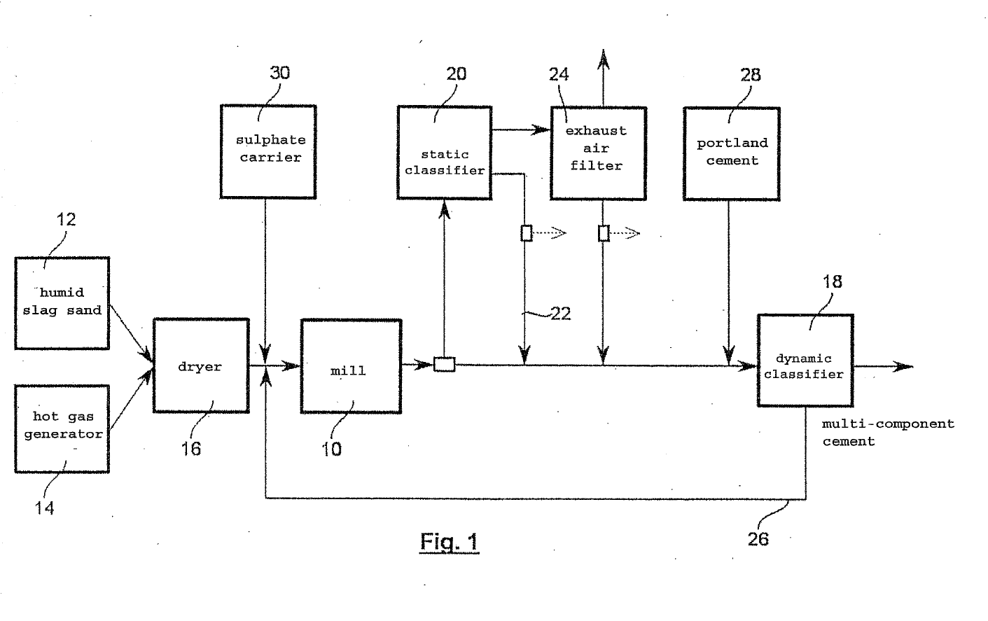

FIG. 1 shows a block diagram of a first embodiment of a grinding installation of the present invention.

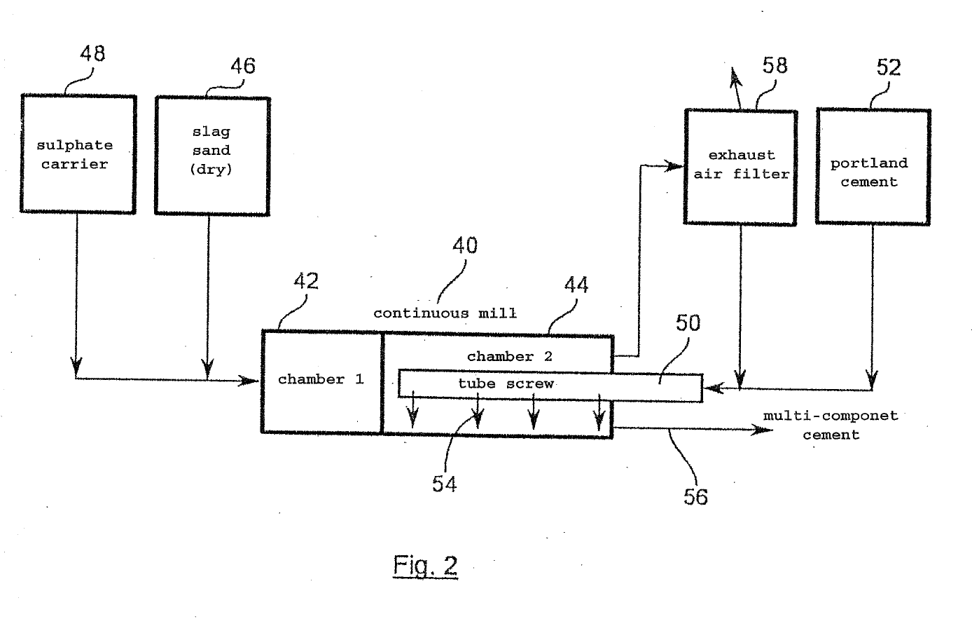

FIG. 2 shows a block diagram of a second embodiment of a grinding installation of the present invention.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

In FIG. 1, a ball mill 10 is shown, which is dimensioned as a slag sand mill in its burdening in particular, that is to say, with balls having 40 to 50 mm at the inlet and about 17 mm at the delivery; with diameter decreasing from the inlet to the delivery. Humid slag sand from a reservoir 12 is given into an ascending pipe dryer 16 by a not shown metering hopper, together with a flow of hot gas that is generated in a hot gas generator 14.

The drying gases charged with water and grinding stock which accrued by the drying in the ascending pipe dryer 16 and consist of gas and solid material, are separated from each other by way of a not shown cyclone and cloth filter. The water vapour arrives in the environment. The solid matter proportions separated in the not shown cyclone and in the not shown cloth filter are the dried slag sand from the ascending pipe dryer 16 and are charged into the ball mill 10. The grinding stock ground in the ball mill 10 leaves the delivery of the mill 10 mainly by mechanical transportation and is guided to a dynamic classifier 18, for instance via a continuous bucket elevator and flow type chutes (not shown).

The ball mill 10 is ventilated by aspiration of cold air. This cold air flow realises a limited pneumatic discharge of grinding stock at the delivery of the ball mill. This pneumatically delivered grinding stock is at first guided over a static classifier 20, the discharged oversized material 22 being guided directly to the conveying paths towards the dynamic classifier 18. The dust-loaded cold gas flow discharged from the static classifier 20 is separated in an exhaust air filter 24. The purified exhaust air arrives in the environment, whereas the solid contents from the filter 24 are also supplied to the dynamic classifier 18. This way of handling ensures the homogeneity of the material composition of the multi-component cements produced by the system.

The dynamic classifier 18 is adjusted to a given cut point. Oversized material of the dynamic classifier or its return, respectively, arrives at the inlet of the ball mill 10 via a back conveyor device 26. Portland cement—standardised or not standardised—is supplied into the described circuit before the dynamic classifier 18 from a reservoir 28. The Portland cement is sized together with the slag meal in a fashion corresponding to the recipe. Depending on the fixed desired fineness of the multi-component system, a small proportion is returned to the inlet of the ball mill 10 as grit and post-refined, as described. The slag sand ball mill is optimally burdened for this post-refining The Portland cement grits are post-refined together with the slag sand.

The Portland cement may be at hand for instance in the finenesses CEM I 32,5 R, CEM I 42,5 R, or CEM I 52,5 R or in special finenesses.

In fact, a sulphate carrier is admixed to the Portland cement, but by the addition of the Portland cement in the grinding of for instance slag sand, the SO₃-content decreases in the generated multi-component cement. In order to optimise the SO₃-content, a reservoir 30 with sulphate carrier is therefore provided, which is also supplied to the inlet of the ball mill 10 via a not shown metering hopper in order to achieve the desired SO₃-proportion in the completed multi-component cement.

In FIG. 2, a continuous mill 40 is shown, with a first chamber 42 and a second chamber 44, each of them containing grinding balls of a given burdening for grinding slag sand. As the case may be, the mill can also be realised as a one-chamber mill. Dry slag sand is supplied to the inlet of the continuous mill 40 from a reservoir 46, together with a sulphate carrier from a reservoir 48, which serves for optimising the SO₃-content in multi-component cements. A tube screw conveyor 50 is guided into the second chamber 44 from out the delivery. The inlet of the tube screw conveyor 50 is connected to a reservoir 52 for Portland cement, and the tube screw transports the Portland cement into the interior of the second chamber 44. The installed tube screw conveyor 50 has for instance four closable outlets 54 that are spaced apart in the longitudinal direction. The number and the closability of the outlets can be chosen arbitrarily. When the Portland cement is charged into the chamber 44 at the end of the tube screw conveyor, there will be a common grinding of the Portland cement with the slag sand across almost the entire length of the second chamber 44. The nearer the outlet of the tube screw conveyor is to the delivery of the continuous mill 40, the less will be the post-refining. An outlet near to the delivery of the mill MBD has the effect that the Portland cement is essentially still only mixed with the slag meal. Completed slag cement leaves the continuous mill 40 via the delivery 56, as already mentioned. The exhaust air from the continuous mill 40 arrives in an exhaust air filter 58, from which the filter dust is also supplied to the inlet of the tube screw conveyor.

This completes the description of the preferred and alternate embodiments of the invention. Those skilled in the art may recognize other equivalents to the specific embodiment described herein which equivalents are intended to be encompassed by the claims attached hereto.

1. A method for producing multi-component cements with the following procedural steps:
one component B of the multi-component cement is ground in a grinding installation MB;
Portland cement is ground as component A in a cement grinding installation MA;
the mechanically discharged grinding stock of the grinding installation MB is supplied to the inlet of a dynamic classifier with adjusted separation cut;
the Portland cement is also supplied to the inlet of the dynamic classifier of the grinding installation MB, and the oversized material of the dynamic classifier of the grinding installation MB is recycled to the inlet of the grinding installation MB, whereas the fine product of the dynamic classifier forms the multi-component cement.

2. A method for producing multi-component cements with the following procedural steps:
one component B of the multi-component cement is ground in a continuous grinding installation MBD having an inlet and a delivery;
Portland cement is ground as component A in a cement grinding installation MA; Portland cement is supplied as component A in the longitudinal direction of the continuous grinding installation MDB into one or plural locations of the continuous grinding installation MDB between inlet and delivery; multi-component cement is taken out of the delivery of the continuous grinding installation MBD;
the component A is supplied at plural locations spaced apart in the longitudinal direction.

3. A method according to claim 2, characterised in that the component B is ground in a grinding installation for a slag sand.

4. A method according to claim 3, characterised in that a ball mill, a roller grinding mill or a material bed roller mill is used.

5. A method according to claim 1 characterised in that the exhaust air dust of the mill is supplied to the inlet of the dynamic classifier of the grinding installation MB.

6. A method according to claim 2, characterised in that the exhaust air dust of the mill is supplied to the continuous grinding installation MBD.

7. A method according to claim 2, characterised in that the Portland cement is charged into the continuous mill MDB by way of a tube screw conveyor.

8. A method according to claim 7, characterised in that the exhaust air dust of the mill is supplied to the continuous grinding installation by a tube screw conveyor.

9. A method according to claim 7, characterised in that the tube screw conveyor has closable outlet openings at longitudinal distances.

10. A method according to claim 1, characterised in that a sulphate carrier is supplied into the grinding installation MB or MDB together with the material that is to be ground.

11. A method according to claim 1, characterised in that the component B is slag sand.

12. An installation for producing a multi-component cement with the following features:
a circulatory-working grinding installation MB for a component B that is to be ground,
a dynamic classifier with adjustable separation cut, connected to the delivery of the grinding installation MB via a conveyor device,
a back conveyor device from a delivery of the dynamic classifier for oversized material towards the inlet of the grinding installation MB,
a reservoir for Portland cement as component A, which is connected to the conveyor device between the delivery of the grinding installation MB and the inlet of the dynamic classifier, and
a reservoir for the component B.

13. An installation for producing a multi-component cement with the following features:
a continuous grinding installation MBD for a component B, whose inlet is connected to a reservoir for the material of the component B that is to be ground,
from out the delivery of the continuous grinding installation MBD for the multi-component cement, a linear conveyor for a component A extends into the continuous grinding installation in the longitudinal direction of the continuous grinding installation MBD,
the linear conveyor is connected to a reservoir for Portland cement for the component A and has at least one outlet within the continuous grinding installation, and
the linear conveyor features several closable outlet openings axially spaced along its extension.

14. with the following features: a continuous grinding installation MBD for a An installation according to claim 12, characterised in that the inlet of the grinding installation MB or that of the continuous grinding installation MDB is connected to a reservoir (48) for a sulphate carrier.

15. An installation according to claim 14, characterised in that a dryer for the humid slag sand is connected before the inlet of the grinding installation MB or MBD, which works in connection with a generator for hot gas.

16. An installation according to claim 12, characterised in that reservoirs for a grinding aid and/or substances for passivating the chromate reaction and/or for substances which influence the product properties of cements and multi-component cements, like for instance the flow behaviour, the concrete compaction, setting accelerators and setting retarders are connected to the inlet of the mill or to the inlet of the dynamic classifier.

17. An installation according to claim 13, characterised in that a dryer for the humid slag sand is connected before the inlet of the grinding installation MB or MBD, which works in connection with a generator for hot gas.

18. An installation according to claim 13, characterised in that reservoirs for a grinding aid and/or substances for passivating the chromate reaction and/or for substances which influence the product properties of cements and multi-component cements, like for instance the flow behaviour, the concrete compaction, setting accelerators and setting retarders are connected to the inlet of the mill or to the inlet of the dynamic classifier.
